(19) United States
(12) Patent Application Publication
(10) Pub. No.: US 2020/0408547 A1
(43) Pub. Date: Dec. 31, 2020

(54) OPTIMUM ROUTE SEARCH DEVICE, GLOBAL SEARCH DEVICE FOR CONTINUOUS OPTIMIZATION PROBLEM AND NON-TRANSITORY TANGIBLE COMPUTER-READABLE STORAGE MEDIUM FOR THE SAME

(71) Applicants: DENSO CORPORATION, Kariya-city (JP); TOHOKU UNIVERSITY, Sendai-shi (JP)

(72) Inventors: Shuntaro OKADA, Kariya-city (JP); Masayoshi TERABE, Kariya-city (JP); Masayuki OHZEKI, Kariya-city (JP)

(21) Appl. No.: 17/017,886

(22) Filed: Sep. 11, 2020

Related U.S. Application Data
(63) Continuation-in-part of application No. PCT/JP2019/008617, filed on Mar. 5, 2019.

(30) Foreign Application Priority Data
Mar. 13, 2018 (JP) 2018-045428

(51) Int. Cl. G01C 21/34; B60W 30/16; G06K 9/00

(52) U.S. Cl. CPC G01C 21/3446; B60W 30/16; B60W 2554/4041; B60W 2554/804; G06K 9/0053

(57) ABSTRACT

An updating unit updates the continuous variable by the gradient method along the minute change of the evaluation function. A selector selects an eigenstate of a harmonic oscillator according to a Boltzmann distribution. An adder adds the value of the eigenstate as a continuous noise to the continuous variable using the existence probability of the selected eigenstate. The updating unit repeats updating by the gradient method using the continuous variable to which the noise is added by the adder.

### CROSS REFERENCE TO RELATED APPLICATION

The present application is a continuation-in-part application of International Patent Application No. PCT/JP2019/008617 filed on Mar. 5, 2020, which designated the U.S. and claims the benefit of priority from Japanese Patent Application No. 2018-045428 filed on Mar. 13, 2018. The entire disclosures of all of the above applications are incorporated herein by reference.

### TECHNICAL FIELD

The present disclosure relates to a global search device for a continuous optimization problem and a non-transitory tangible computer-readable storage medium for the same.

### BACKGROUND

An attempt has been made to search for a global minimum point by utilizing the quantum tunnel effect with applying an error function having a plurality of local minimum points. According to the technique, the true minimum value is calculated by the quantum mechanical tunnel effect according to a design constant to be replaced with a portion corresponding to a Planck's constant of a dynamic system and a coefficient of friction that defines a change rate of an expulsion of the dynamic system in a time differential equation that defines the time evolution of the dynamic system.

### SUMMARY

An updating unit updates the continuous variable by the gradient method along the minute change of the evaluation function. A selector selects an eigenstate of a harmonic oscillator according to a Boltzmann distribution. An adder adds the value of the eigenstate as a continuous noise to the continuous variable using the existence probability of the selected eigenstate. The updating unit repeats updating by the gradient method using the continuous variable to which the noise is added by the adder.

### BRIEF DESCRIPTION OF THE DRAWINGS

The above and other objects, features and advantages of the present disclosure will become more apparent from the following detailed description made with reference to the accompanying drawings. In the drawings:

FIG. 1A is an electrical configuration diagram showing a first embodiment;

FIG. 1B is a functional block diagram;

FIG. 2 shows an example of an evaluation function;

FIG. 3 is a diagram showing an eigenvalue and an eigenstate of a quantum mechanical harmonic oscillator;

FIG. 4 shows the peak position of the eigenstate;

FIG. 5 is a flowchart showing the content of the derivation process of the optimal solution;

FIG. 6 is an explanatory diagram showing a processing image of the gradient method;

FIG. 7 is an explanatory diagram showing an escape image of a local solution using a tunnel effect;

FIG. 8 is a flow chart showing the content of the derivation process of an optimal solution according to the second embodiment;

FIG. 9 is an explanatory diagram showing a processing image by a simulated annealing method; and

FIG. 10 is a flowchart showing the content of the derivation process of an optimal solution according to the third embodiment.

### DETAILED DESCRIPTION

According to a conceivable technique, although the use of the quantum mechanical tunnel effect is described, there is no description and suggestion how to update the variables and how to avoid the local solution. For example, when considering the optimization variable as the coordinate of the physical system and the evaluation function as the potential function of the physical system, there is no description or suggestion which quantum fluctuation causes the tunnel effect, and no suggestion about the concrete form of the time differential equation that defines the time evolution of the physical system. In other words, the above technique merely suggest that the tunnel effect is used, and does not suggest any optimization method using the tunnel effect.

A global search device and a non-transitory tangible computer-readable storage medium for a continuous optimization problem are provided to solve an optimization problem of a continuous variable with high accuracy using a tunnel effect.

A first aspect of the present disclosure is directed to a global search device for a continuous optimization problem that searches for an optimal solution that satisfies a condition that an evaluation function generated using a continuous variable has a minimum value or a maximum value. According to the first aspect, the continuous variable is updated by the gradient method along the small change of the evaluation function, the eigenstate of the harmonic oscillator is selected according to the Boltzmann distribution, the value of the eigenstate as a continuous noise is added to the continuous variable using the existence probability of the selected eigenstate, and the updating by the gradient method is repeated using the continuous variable to which the noise is added. Therefore, by adding the continuous noise to the continuous variable, it becomes possible to avoid the local solution using the tunnel effect, and the optimization problem of the continuous variable can be solved with high accuracy.

Further, according to the second aspect of the present disclosure, the continuous variable is updated by the gradient method along the small change of the evaluation function, the eigenstate of the harmonic oscillator is selected according to the Boltzmann distribution, a value is randomly selected as a discrete noise that satisfies a condition such that the existence probability of the selected eigenstate becomes a peak, the energy difference before and after adding the discrete noise is calculated, a determination is made whether a probability that depends on the predetermined temperature according to the evaluation function is accepted or not. When it is not accepted, the discrete noise is set to be 0, and when accepted, the selected discrete noise is added to the continuous variable. thus, the updating is repeated by the gradient method using the continuous variable to which the discrete noise is added. Therefore, by adding the discrete noise to the continuous variable, it becomes possible to avoid the local solution using the tunnel effect, and the optimization problem of the continuous variable can be solved with high accuracy.

Hereinafter, some embodiments of a global search device and a program for a continuous optimization problem embodying the present disclosure will be described with reference to the drawings. In the following embodiments, a part having the same function or similar function will be described by giving the same reference numeral or similar reference numeral (for example, by adding a subscript “a”) among the embodiments. The description of the linked operation having the same or similar function will be omitted as necessary.

### First Embodiment

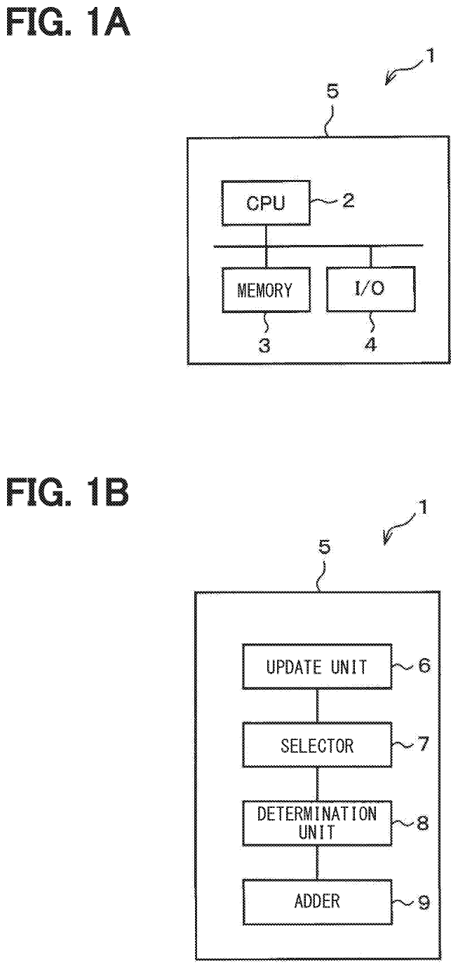

FIG. 1A to FIG. 7 show explanatory diagrams of a first embodiment. The device 1 shown in FIG. 1A is configured as a global search device for a continuous optimization problem that executes a simulation of optimization processing of an optimization problem by utilizing quantum mechanical properties.

The device 1 is configured by using a general-purpose computer 5 in which a CPU 2, a memory 3 such as a ROM and a RAM, and an input/output interface 4 are connected via a bus. The computer 5 executes the conversion program stored in the memory 3 by the CPU 2 and executes various procedures to execute the global search process. The memory 3 is used as a non-transitory tangible storage medium.

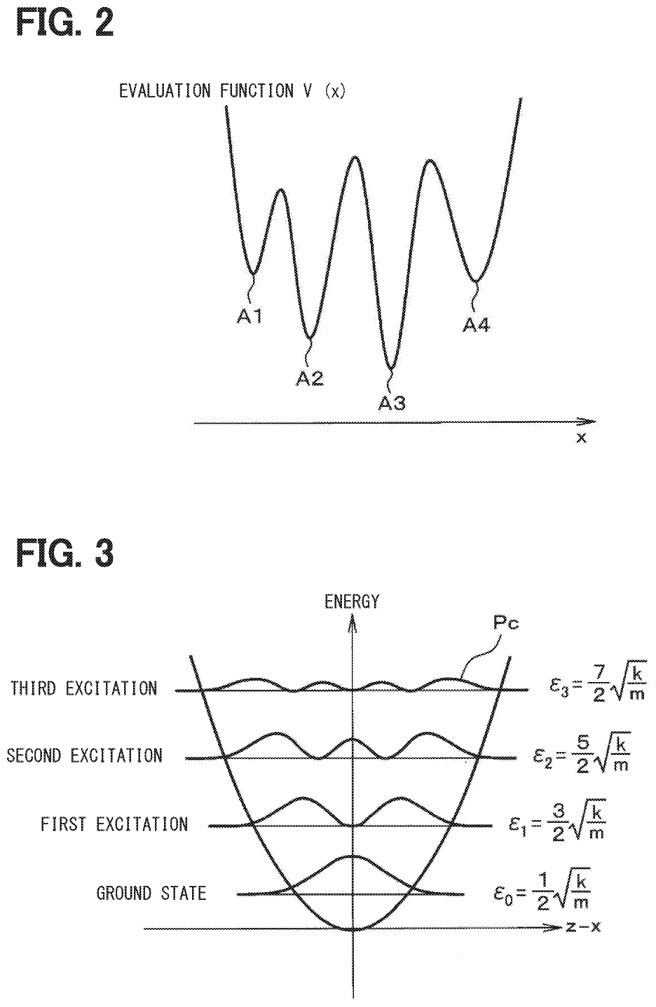

The global search process executed by the computer 5 is a process for assuming a search space including a Euclidean space having one or more N dimensions, and obtaining a continuous variable x, i.e., an optimum solution (A3 in FIG. 2) that is disposed in this search space and satisfies a condition that an evaluation function V( ) generated by a plurality of requests and constraints becomes a minimum value. As shown in FIG. 1B, the computer 5 includes various functions as an updating unit 6, a selector 7, a determination unit 8, and an adder 9 as the functions to be realized.

The evaluation function V( ) is generated according to a plurality of requirements or constraints, as shown in FIG. 2, for example. The function is represented by an equation having one or more N continuous variables as a parameter, and, for example, an arbitrary polynomial, a rational function, an irrational function, an exponential function, a logarithmic function, a combination of them connected by addition, subtraction, multiplication and division.

As shown in FIG. 2, the evaluation function V( ) is a function that changes according to the continuous variable x and includes a number of local minimum values. Under this condition, the computer 5 obtains the optimum solution A3 of the continuous variable x that satisfies the minimum value among the local minimum values of the evaluation function V( ). There are many local solutions A1, A2, A4 of the continuous variable x that satisfy the condition such that the evaluation function V( ) shows the local minimum value. Therefore, even if the computer 5 solves this problem, it may obtain one of local solutions A1, A2, and A4. Therefore, in the present embodiment, the computer 5 uses the quantum mechanical tunnel effect to avoid the local solutions A1, A2, and A4 to obtain the optimum solution A3.

<Introduction of the Concept of Quantum Fluctuations>

In order to avoid a local solution (for example, A4) by causing a quantum mechanical tunnel effect in the evaluation value V(x) of the evaluation function V( ), the concept of quantum fluctuation is introduced in this embodiment. In this embodiment, the Hamiltonian H\hat{ }(m) of quantum annealing is given as shown in the following equation (1). m indicates mass.

$$\begin{matrix}( Equation 1 ) & \\ \hat{H} ( m ) = V ( \hat{x} ) - \frac{{\hat{p}}^{2}}{2 m} & ( 1 )\end{matrix}$$

In equation (1), x is a continuous variable, and quantum annealing with the evaluation function V( ) as a potential is introduced. The second term on the right side of the equation (1) represents an introduction term of quantum fluctuation using the operator p\hat{ } of the momentum p. In the equation (1), it is desirable to set the mass m to be a sufficiently small value in the initial state to strengthen the influence of the introduction term of the quantum fluctuation, that is, the second term on the right side of the equation (1). By increasing the mass m as the search process proceeds, the influence of the evaluation function V( ) of the first term on the right side of the equation (1) is strengthened, and the influence of the introduction term of the quantum fluctuation of the second term on the right side is decreased. Then, at the beginning of the search, the continuous variable x varies, for example, globally due to the influence of quantum fluctuation, and is greatly affected by the evaluation function V( ) as the search process proceeds, for example, so that the optimum solution A3 is locally obtained.

<Process of Updating Continuous Variable x>

When the updating process of the continuous variable x is applied to a quantum system, it can be described by a time-dependent Schrodinger equation, but it is unrealistic to solve the Schrodinger equation because a huge amount of calculation is required. Therefore, when evaluating the performance of quantum annealing, it is rare to use the method of directly solving the Schrodinger equation, and in practice, for example, it is desirable to obtain an equilibrium state under a condition that the temperature T is a cryogenic temperature. The updating process of the continuous variable x is executed so as to converge to an equilibrium state. By using the Monte Carlo method to perform the calculation processing so as to converge to the equilibrium state, it becomes possible to update the optimization variable with a much smaller amount of calculation than solving the Schroedinger equation.

<Interpretation of Partition Functions and Quantum Fluctuations>

By using the Hamiltonian H\hat{ }(m) in the equation (1), the partition function can be expressed as in the equation (2).

$$\begin{matrix}( Equation 2 ) & \\ Z = Tr exp \{ - β [ V ( \hat{x} ) + \frac{{\hat{p}}^{2}}{2 m} ] \} & ( 2 )\end{matrix}$$

In the equation (2), β represents a thermal noise (=1/T). Further, Tr represents a trace and represents the diagonal sum of the matrix. Then, when the equation (2) is separated into variables, the partition function can be expressed as the equation (3). In this equation (3), k is made infinite and the limit value of the content of the exponential function exp is acquired, so that the equation is constrained by the L2 norm of ∥zx∥\hat{ }2.

$$\begin{matrix}( Equation 3 ) & \\ Z = Tr {lim}_{k \to ∞} exp \{ - β [ y ( \hat{z} ) + \frac{k}{2} {‖ \hat{z} - \hat{x} ‖}_{2}^{2} + \frac{1}{2 m} {\hat{p}}_{x}^{2} ] \} & ( 3 )\end{matrix}$$

The partition function of equation (3) can be interpreted as the sum of the evaluation function V(z) and the quantum mechanical harmonic oscillator with z as a center. From this fact, when the continuous variable x is updated, the noise component due to the quantum mechanical harmonic oscillator is added while applying the gradient method of updating the continuous variable x according to the minute change of the evaluation function V( ). Thus, it becomes possible for the continuous variable x to avoid the local solutions A1, A2, A4 by the quantum tunnel effect and to reach the optimum solution A3.

<Explanation of Quantum Mechanical Harmonic Oscillator>

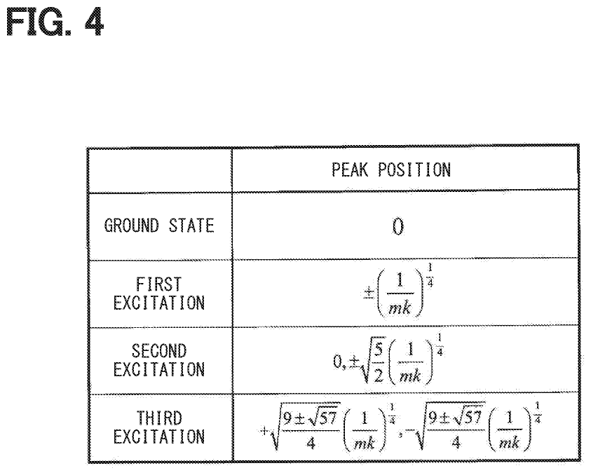

The eigenvalue and eigenstate of a quantum mechanical harmonic oscillator are shown in FIG. 3. The curve of the n-th excitation state of each eigenstate represents the existence probability Pc of each state. When the ground state is defined as the zeroth excited state, then n≥0 is satisfied. Further, FIG. 4 shows z-x positions of the harmonic oscillator that satisfies a condition that the existence probability Pc satisfies the peak condition in the ground state to the third excitation state.

That is, as shown in FIG. 4, the position satisfying the peak condition is 0 in the ground state. Further, the position where the existence probability Pc satisfies the peak condition in the first excited state is the expression (4).

$$\begin{matrix}( Equation 4 ) & \\ \pm {( \frac{1}{m k} )}^{\frac{1}{4}} & ( 4 )\end{matrix}$$

Here, m is a mass and k is a spring constant. The position where the existence probability Pc satisfies the peak condition in the second excited state is the following equation (5).

$$\begin{matrix}( Equation 5 ) & \\ 0 , \pm \sqrt{\frac{5}{2}} {( \frac{1}{m k} )}^{\frac{1}{4}} & ( 5 )\end{matrix}$$

Further, the position where the existence probability Pc satisfies the peak condition in the third excited state is the expression (6).

$$\begin{matrix}( Equation 6 ) & \\ + \sqrt{\frac{9 \pm \sqrt{57}}{4}} {( \frac{1}{m k} )}^{\frac{1}{4}} - \sqrt{\frac{9 \pm \sqrt{57}}{4}} {( \frac{1}{m k} )}^{\frac{1}{4}} & ( 6 )\end{matrix}$$

<Selection of the Eigenstate of the Harmonic Oscillator>

Considering such an eigenstate of the harmonic oscillator, it is advisable to select the eigenstate with a predetermined probability according to the Boltzmann distribution of the temperature T (=1/β). According to this Boltzmann distribution, the selection probability Posc(n) of the n-th excitation state (with n≥0) can be expressed by the following equation (7-1). Here, Zosc can be expressed by equation (7-2).

$$\begin{matrix}( Equation 7 ) & \\ {P}_{osc} ( n ) = \frac{1}{{Z}_{osc}} exp [ - β \sqrt{\frac{k}{m}} ( n * \frac{1}{2} ) ] & ( 7 \text{-} 1 ) \\ {Z}_{osc} = {\sum }_{n = 0}^{{N}_{osc}} exp [ - β \sqrt{\frac{k}{m}} ( n + \frac{1}{2} ) ] & ( 7 \text{-} 2 )\end{matrix}$$

In theory, there are an infinite number of eigenstates of the harmonic oscillator, but if all eigenstates are taken into consideration, the amount of calculation would greatly increase with respect to the required accuracy. Thus, it is desirable to select from excited states in a predetermined range according to the required accuracy. Further, it is desirable to select a finite number Nosc of excited states from the ground state having the lowest energy and to select one of them.

<Addition Method of Discrete Noise Δquantum Based on Harmonic Oscillator>

The noise due to the harmonic oscillator is such that, after selecting the eigenstate by the Boltzmann distributions of the equations (7-1) and (7-2), the value satisfying the condition that the existence probability Pc of the selected eigenstate becomes a peak is added to the continuous variable x as the discrete noise Δquantum. As shown in FIG. 3, there are values that satisfy the high probability condition in addition to the value that satisfy the condition that the existence probability Pc becomes a peak, but the calculation amount can be reduced by considering only the condition that becomes a peak. Moreover, by adding the discrete noise Δquantum, the local solutions A1, A2, A4 can be easily avoided by the tunnel effect.

<Derivation Method of Optimal Solution A3>

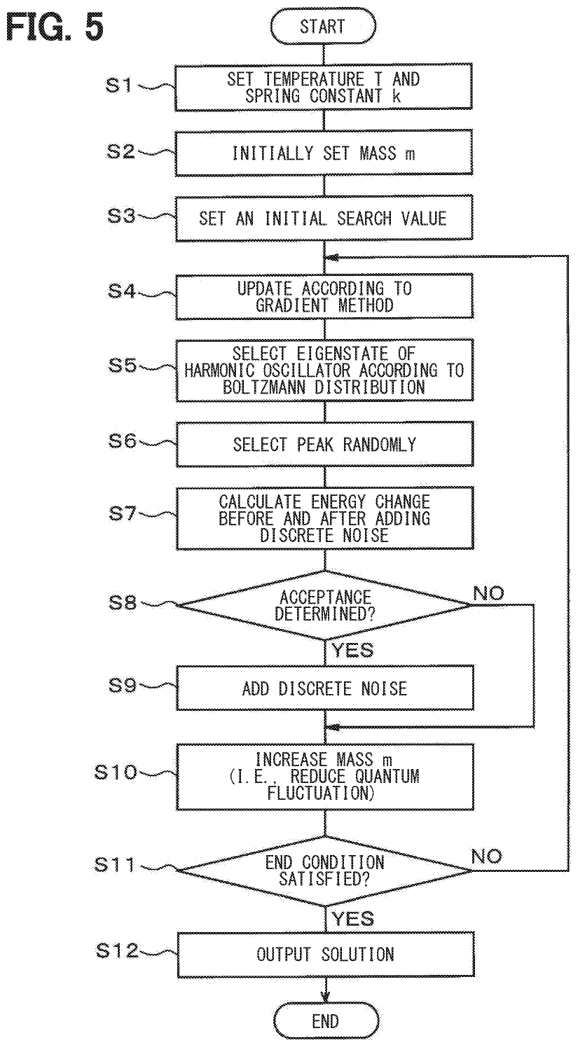

In the following, an actual method for the computer 5 to actually derive the optimum solution A3 will be described under such a technical meaning. FIG. 5 is a flowchart schematically showing the details of the derivation process of the optimum solution A3.

The computer 5 initializes the temperature T and the spring constant k as constants in S1 of FIG. 5, and initializes the mass m as a variable in S2. Since the temperature T and the spring constant k are parameters that are determined depending on the evaluation function VQ, it is desirable to calculate them in advance as a constant by using, for example, a simulation. Further, in the initial state, it is desirable to set the mass m to be a small predetermined variable value in advance.

Furthermore, the computer 5 randomly sets the initial value of the continuous variable x in S3, for example. Then, the computer 5 substitutes the initial value of the continuous variable x into the evaluation function V( ) to calculate the evaluation value V(x), and then updates the continuous variable x using the gradient method in S4. In the gradient method, it is desirable to update the continuous variable x along with a minute change in the evaluation function V( ) as shown in the following equation (8).

x*=x−η∇V(x) (Equation 8)

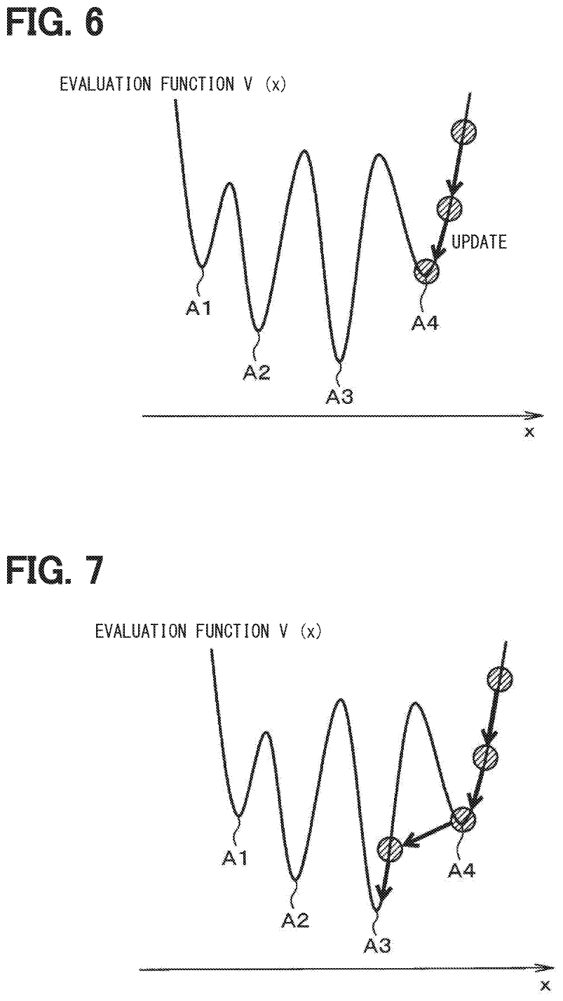

Here, n represents a predetermined coefficient used in the gradient method, x represents a continuous variable before updating, and x\hat{ }* represents a continuous variable after updating by the gradient method. FIG. 6 shows an image of updating the continuous variable x by the gradient method. As shown in FIG. 6, the continuous variable x is updated in the direction of decreasing along the gradient of the evaluation function V( ). After that, the computer 5 selects the n-th excited state as the eigenstate of the harmonic oscillator according to the Boltzmann distribution in S5. At this time, the n-th excited state is selected according to the Boltzmann distribution of the equations (7-1) and (7-2).

As described above, theoretically, there are an infinite number of eigenstates of the harmonic oscillator, but if all eigenstates are taken into consideration, the amount of calculation would greatly increase with respect to the required accuracy. Thus, it is desirable to select from the n-th excited state in a predetermined range according to the required accuracy. Further, it is desirable to select a finite number Nosc of excited states from the ground state having the lowest energy and to select one of them. Then, the calculation amount can be reduced.

For example, when the computer 5 selects the first excited state in S5, that is n=1, any one of the values satisfying the conditions of two peaks represented by the equation (4) of the first excited state in S6 is randomly selected, so that the value is selected to be the discrete noise Δquantum. At this time, the computer 5 selects a plurality of peaks to be selected with the same probability of 50% in this case, and sets the selected value as the discrete noise Δquantum. After that, the computer 5 calculates the energy change ΔV before and after adding the discrete noise Δquantum to the continuous variable x in S7 according to the following equation (9).

ΔV=V(x*+Δquantum)−V(x*) (Equation 9)

Then, the computer 5 may perform acceptance determination for this energy change ΔV with a probability depending on the temperature T set depending on the evaluation function V( ). The acceptance determination method may be the metropolis method or the heat bath method. For example, when the metropolis method is used, the computer 5 accepts 100% when ΔV=0, and when the ΔV>0, the computer 5 accepts the probability of exp(−ΔV/T) depending on the temperature T, for example. And, in other cases, the computer 5 discards the acceptance. When the computer 5 accepts this content, it determines YES in S8, and adds the discrete noise Δquantum to the continuous variable x to update the variable x.

Then, the computer 5 increases the mass m in S10. As the mass m increases, the influence of the evaluation function V( ) of the first term on the right side of the equation (1) becomes stronger, and at the same time, the influence of the quantum fluctuation introduction term of the second term on the right side becomes weaker.

After that, the computer 5 repeats the processes of S4 to S10. Specifically, the computer 5 repeats the processes of S4 to S10 while increasing the mass m. Therefore, the influence of the evaluation function V( ) corresponding to the first term on the right side of the equation (1) is gradually increased, and the influence of the introduction term of the quantum fluctuation shown in the second term on the right side of the equation (1) is gradually decreased.

After that, the computer 5 presumes that the optimization is performed when the termination condition is satisfied in S11, and outputs the solution in S12, and terminates the process. The ending condition at S11 may be a condition that the mass m gradually increasing in S10 reaches the upper limit value, or a condition that a predetermined time has elapsed from the start of the process, or a condition that the processes of S4 to S10 are repeated a predetermined numerical number of times or more, or a condition that the energy change ΔV calculated in S7 becomes a predetermined value or less. That is, various conditions may be applied as the ending condition of S11.

<Explanation of Technical Image>

When the computer 5 updates the continuous variable x by the gradient method in S4, as shown in the technical image in FIG. 6, the continuous variable x is updated only in the direction in which the evaluation function V( ) decreases. Therefore, once the local solution A4 shown in FIG. 6 is fitted, the local solution A4 cannot be avoided. However, when the computer 5 executes the processes of S5 to S10 of the present embodiment and the acceptance determination is made in S8, it is possible to generate the tunnel effect based on the energy change ΔV in which the discrete noise Δquantum is added to the continuous variable x. As shown in the image in FIG. 7, the local solution A4 can be escaped by the tunnel effect, and by repeating the gradient method, the optimal solution A3 can be obtained. In particular, by simulating the tunnel effect due to quantum fluctuation, it is possible to efficiently escape this local solution A4 even when it fits into a sharp and deep local solution A4.

### Summary of this Embodiment, Effects

As described above, according to this embodiment, the computer 5 updates the continuous variable x by the gradient method along the minute change of the evaluation function V( ), and selects the eigenstate of the harmonic oscillator according to the Boltzmann distribution, randomly selects a value, as the discrete noise Δquantum, that satisfies the condition that the existence probability Pc of the selected n-th excited state becomes a peak, calculates the energy difference before and after the addition of the discrete noise Δquantum, and determines whether a probability depending on the preset temperature T, which is preliminarily set depending on the evaluation function V( ), is accepted, sets the discrete noise Δquantum to be 0 when not accepted, adds the selected discrete noise Δquantum to the continuous variable x when accepted, and updates repeatedly by the gradient method using the continuous variable x to which the discrete noise Δquantum is added. Therefore, the local solution A1, A2, A4 can be escaped by using the tunnel effect to derive the optimum solution A3, and the optimization problem of the continuous variable x can be solved with high accuracy.

(Modification)

In the above description, the computer 5 has the mode in which the eigenstate is selected according to the Boltzmann distributions of the equations (7-1) and (7-2) in S5. Alternatively, instead of this stochastic selection processing, the first excited state may always be selected as the eigenstate of the harmonic oscillator. At this time, the local solutions A1, A2, and A4 can be escaped by using the tunnel effect of the discrete noise Δquantum while reducing the amount of calculation for selecting the eigenstate, and the optimization problem of the continuous variable x can be solved with high accuracy.

### Second Embodiment

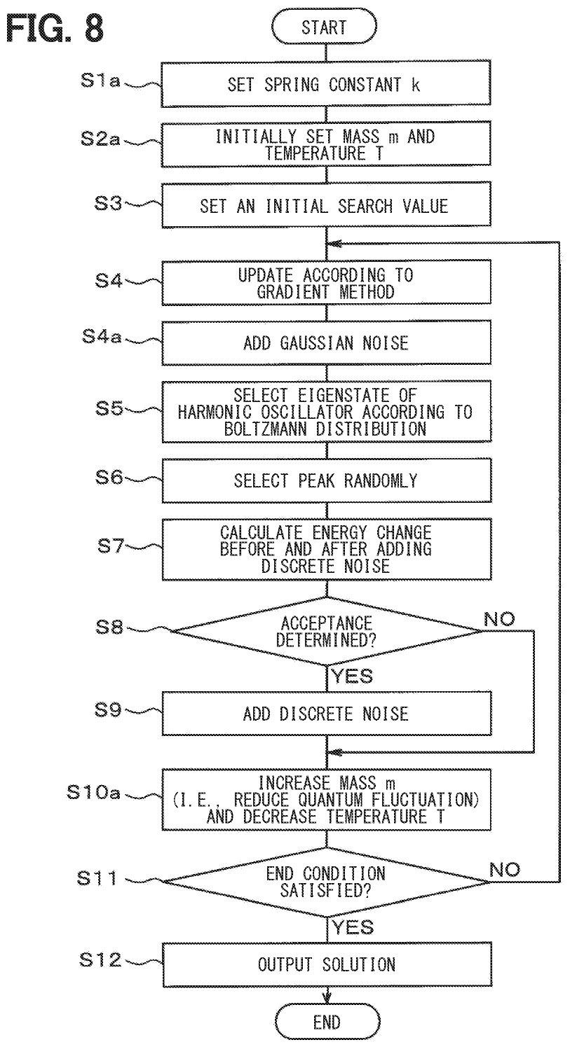

FIG. 8 shows an additional explanatory diagram of the second embodiment. The second embodiment differs from the first embodiment in that the simulated annealing method is applied. Further, the Gaussian noise Δthermal is added to the discrete noise Δquantum while using the temperature T as a variable. Hereinafter, the identical parts as those in the first embodiment will be designated by the same reference numerals for simplification of the description. Only differences from the first embodiment will be described below.

FIG. 8 is a flowchart showing the details of the derivation process of the optimum solution A3. The computer 5 sets the spring constant k as a constant as shown in S1a of FIG. 8, and initializes the mass m and the temperature T as variables as shown in S2a. Since the spring constant k is a parameter that is determined depending on the evaluation function V( ) in the present embodiment, it is desirable to calculate it in advance as a constant by using, for example, a simulation.

Further, in the initial state, the mass m may be set to a small predetermined variable value in advance, and the temperature T may be set to a high predetermined value in advance. After that, the computer 5 randomly sets the initial value of the continuous variable x in S3, for example. Then, the computer 5 substitutes the initial value of the continuous variable x into the evaluation function V( ) to calculate the evaluation value V(x), and then updates the continuous variable x using the gradient method in S4. Since the gradient method is the same as the method described in the first embodiment, the description is omitted. In the present embodiment, the computer 5 adds the Gaussian noise thermal to the continuous variable x updated in S4a. Here, this Gaussian noise thermal can be expressed as in the following equation (10).

(Equation 10)

\sqrt{2Tη}N(0,1) (10)

In this equation (10), T is temperature, η is a coefficient of gradient method, and N(0,1) is Gaussian distribution with an average of 0 and variance of 1.

After that, the computer 5 selects the eigenstate of the harmonic oscillator with a predetermined probability according to the Boltzmann distribution in S5. At this time, the computer 5 may select the eigenstate according to, for example, the Boltzmann distribution shown in the equations (7-1) and (7-2). When the computer 5 selects, for example, the first excited state in S5, the computer 5 randomly selects one of the two peaks represented by the equation (4) of the first excited state in S6. At this time, the computer 5 selects a plurality of peaks to be selected with the same probability of 50% in this case, and sets the selected value as the discrete noise Δquantum.

After that, the computer 5 calculates the energy change ΔV before and after adding the discrete noise Δquantum to the continuous variable x in S7 as in the equation (9), and performs the acceptance determination in S8 as in the above embodiment. That is, assuming that the continuous variable x immediately after being updated by the gradient method is defined as x\hat{ }*, the energy change ΔV before and after the addition of the discrete noise Δquantum is calculated, for example, by the following equation (11).

(Equation 11)

ΔV=V(x*+Δₜₕₑᵣₘₐₗ+Δ_{quantum})−V(x*+Δₜₕₑᵣₘₐₗ (11)

After that, the computer 5 makes an acceptance decision for this energy change ΔV with a probability depending on the temperature T. The acceptance determination method may be the metropolis method or the heat bath method. For example, when the Metropolis method is used, the computer 5 accepts 100% when ΔV≤0, accepts it with a probability of exp(−ΔV/T) when ΔV>0, and otherwise, denies the acceptance. When the computer 5 accepts this content, it determines YES in S8, and adds the discrete noise Δquantum to the continuous variable \hat{x}+Δthermal to update the continuous variable x in S9.

Then, the computer 5 decreases the temperature T while increasing the mass m in S10a. As described in the first embodiment, as the mass m increases, the effect of the evaluation function V( ) of the first term on the right side of Equation (1) becomes stronger, and at the same time, the effect of the introduction term of the quantum fluctuation of the second term on the right side of the equation (1) becomes weaker. Further, when the temperature T decreases, the influence of the Gaussian noise Δthermal shown in the expression (10) also weakens.

After that, the computer 5 repeats the processes of S4 to S10a, and specifically, repeats the processes of S4 to S10 while increasing the mass m and decreasing the temperature T. Therefore, the influence of the evaluation function V( ) corresponding to the first term on the right side of the equation (1) is gradually strengthened, and the influence of the introduction term of the quantum fluctuation shown in the second term on the right side of the equation (1) is gradually weakened, and further, the influence of the Gaussian noise Δthermal is gradually weakened.

The computer 5 repeats the processing of S4 to S10a, presumes that the optimization is performed when the termination condition is satisfied in S11, outputs a solution in S12, and terminates the processing. Since the same condition as in the first embodiment may be used as the ending condition of S11, the description thereof will be omitted.

<Explanation of Technical Image>

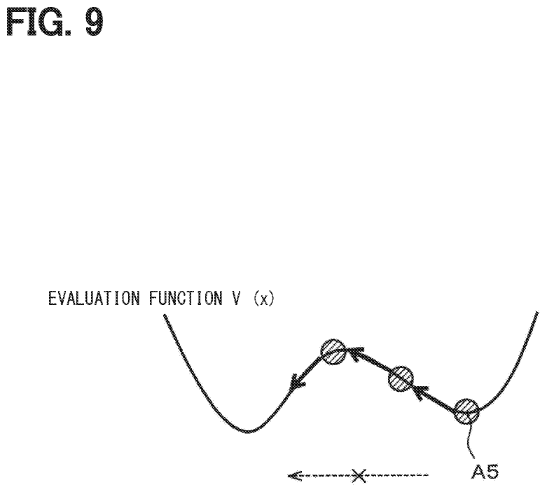

When the computer 5 updates the continuous variable x by the gradient method in S4, as shown in the image in FIG. 6, the continuous variable x is updated only in the direction in which the evaluation function V( ) decreases. For example, as shown in FIG. 9, even if it is assumed that the evaluation function V( ) changes relatively gently, once fitted to the local solution A5, it cannot escape from the local solution A5. However, when the computer 5 uses the simulated annealing method in which the Gaussian noise Δthermal is added to the continuous variable x, in the area of the continuous variable x in which the evaluation function V( ) changes relatively gently, as shown in FIG. 9, for example, the evaluation function V( ) can be updated in a direction in which it gradually rises, the peak of the extreme value of the evaluation function V( ) can be raised, and the local solution A5 can be escaped. As a result, the local solution A5 can be efficiently escaped even from a gentle and wide valley by adding the Gaussian noise Δthermal.

Further, in the present embodiment, since the Gaussian noise Δthermal is introduced together with the discrete noise Δquantum, it is possible to perform a highly accurate search even in the evaluation function V( ) in which sharp and high valleys and gentle and wide valleys are mixed.

As described above, according to the present embodiment, the computer 5 gradually lowers the temperature T when repeating the updating of the continuous variable x, and adds the Gaussian noise that depends on the temperature T together with the discrete noise Δquantum to the continuous variable x. Thus, it is possible to escape from the local solution A5 by ascending the extreme peak of the evaluation function VQ, and searches the optimum solution with high accuracy even in the evaluation function V( ) in which sharp and high valleys and gentle and wide valleys are mixed.

### Third Embodiment

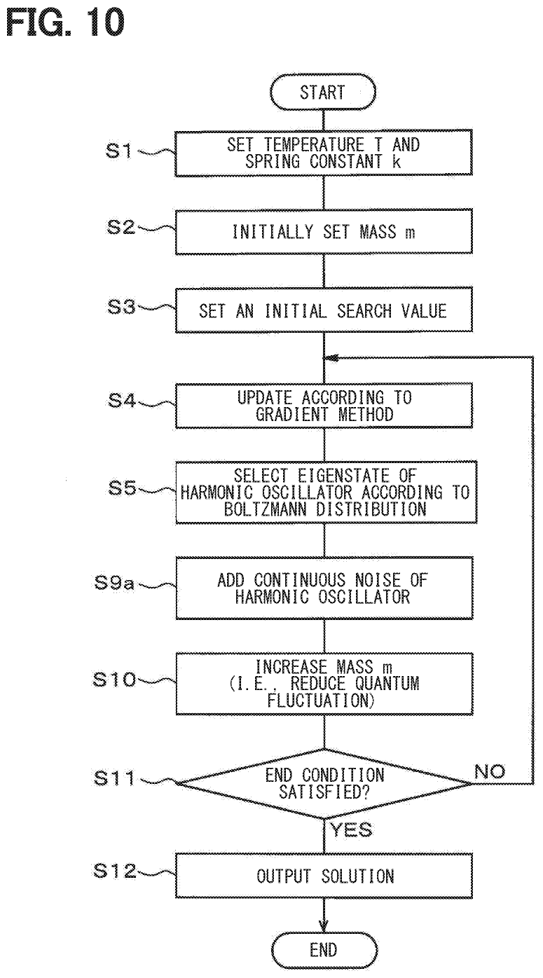

FIG. 10 shows an additional explanatory diagram of the third embodiment. The third embodiment differs from the first embodiment in that the value of the n-th excited state is added to the continuous variable x as a continuous noise. Hereinafter, the identical parts as those in the first embodiment will be designated by the same reference numerals for simplification of the description. Only differences from the first embodiment will be described below.

FIG. 10 is a flowchart showing the details of the derivation process of the optimum solution A3. The computer 5 executes the processes of S1 to S5 of FIG. 10, as shown in the first embodiment. Here, the computer 5 selects the eigenstate of the harmonic oscillator with a predetermined probability according to the Boltzmann distribution in S5. At this time, the eigenstate is selected in accordance with the Boltzmann distribution shown in the equations (7-1) and (7-2). After that, the computer 5 adds the value of the n-th excited state of the harmonic oscillator as a continuous noise to the continuous variable x by using the existence probability Pc of the selected eigenstate (at S9a). Here, since the noise is added without performing the acceptance/discard determination, the determination process can be reduced.

Then, the computer 5 increases the mass m in S10. As the mass m increases, the influence of the evaluation function V( ) of the first term on the right side of the equation (1) becomes stronger, and at the same time, the influence of the quantum fluctuation introduction term of the second term on the right side becomes weaker. After that, the computer 5 repeats the processes of S4 to S10. Specifically, the computer 5 repeats the processes of S4 to S10 while increasing the mass m. Therefore, the influence of the evaluation function V( ) corresponding to the first term on the right side of the equation (1) is gradually increased, and the influence of the introduction term of the quantum fluctuation shown in the second term on the right side of the equation (1) is gradually decreased.

After that, the computer 5 presumes that the optimization is performed when the termination condition is satisfied in S11, and outputs the solution in S12, and terminates the process. Since the same condition as in the first embodiment may be used as the ending condition of S11, the description thereof will be omitted.

As described above, according to the present embodiment, the continuous variable x is updated by the gradient method along the minute change of the evaluation function VQ, the eigenstate of the harmonic oscillator is selected according to the Boltzmann distribution, and the value of the n-th excited state is added to the continuous variable x as the continuous noise using the existence probability Pc of the selected eigenstate, and updates by the gradient method using the continuous variable x to which the noise is added, and repeats updating. Even when such a process is performed, the same effects as those of the first embodiment can be obtained, and the optimum solution A3 can be derived with high accuracy using the tunnel effect.

### Other Embodiments

The present disclosure is not limited to the above-described embodiments, i.e., may be modified or expanded in the following manner.

Although the form in which the minimum value of the evaluation function V( ) is searched as the optimal solution A3 is described, the maximum value may be applied as the optimal solution A3.

The computer 5 and the method described in the present disclosure may be implemented by a special purpose computer which is configured with a memory and a processor programmed to execute one or more particular functions embodied in computer programs of the memory. Alternatively, the computer 5 and the method described in the present disclosure may be implemented by a special purpose computer configured as a processor with one or more special purpose hardware logic circuits. Alternatively, the computer 5 and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

It is also possible to combine the configurations and processing contents of the above-described embodiments. In addition, the reference signs in parentheses described in the claims indicate correspondence relationships with specific devices described in the above-described embodiments as one aspect of the present disclosure, and the technical scope of the present disclosure is not limited. A part of the above-described embodiment may be eliminated as long as the problem identified in the background is resolvable. Also, all conceivable aspects to an extent not departing from the essence specified by the wording defined by the claims can be also regarded as embodiments.

Although the present disclosure is made based on the above-described embodiments, the present disclosure is not limited to the disclosed embodiments and configurations. The present disclosure covers various modification examples and equivalent arrangements. In addition, various modes/combinations, one or more elements added/subtracted thereto/therefrom, may also be considered as the present disclosure and understood as the technical thought thereof.

In the drawing, 1 is a device (i.e., a global search device for continuous optimization problem), 5 is a computer, 6 is an updating unit, 7 is a selecting unit, 8 is a determining unit, and 9 is an adding unit.

Here, for example, a driving support device has been developed as a measure to prevent accidents, and in particular, a driving support device has been developed to reduce the driver's burden for driving. When this type of driving support device searches for a route, the position and speed on a route are each defined as a function according to time, and an evaluation function based on the functions corresponding to the position and speed is introduced, so that an optimum route can be searched for by acquiring the position and speed that satisfy an extreme value (for example, a minimum value) of the evaluation function.

For example, the value of the evaluation function of the route of a movable body (referred to as the evaluation value) can be set according to the position and the speed (for example, the relative position with respect to another vehicle, and the difference between the current speed and the speed limit), and the evaluation function can be expressed by a function with the position x(t) and the speed v(t) as variables. Here, the position x(t) and the speed v(t) have a relation of equality constraint expressed by x(t+1)=x(t)+v(t).DELTA.t. Routes that do not satisfy the equality constraint may be unrealistic as the route of the movable body, so that it may be necessary to always output a route that satisfies the equality constraint. However, the route search is a real-time process, and it may be assumed that a solution is output before obtainment of an extreme value is completed. For this reason, a method of creating the extreme value that always satisfies the equality constraint may be necessary even in the middle of creation of the extreme value.

In the above embodiments, for searching the optimum route of a vehicle, the speed and the position of the vehicle provide the continuous variable, and the evaluation function is provided by a function with the relative position between the vehicle and another vehicle and the difference between the target speed and the actual speed of the vehicle as a variable.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An optimum route search device for searching an optimum route of a vehicle that satisfies a condition that an evaluation function with a relative position between the vehicle and another vehicle and a speed difference between a target speed and an actual speed of the vehicle as variables has a minimum value or a maximum value, the optimum route search device comprising:
an updating unit for updating the relative position and the speed difference by a gradient method along a minute change of the evaluation function;
a selector for selecting an eigenstate of a harmonic oscillator according to a Boltzmann distribution; and
an adder for adding a value of a selected eigenstate to each of the relative position and the speed difference as a continuous noise using an existence probability of the selected eigenstate, wherein:
the updating unit repeats updating the relative position and the speed difference by the gradient method by adding the continuous noise to each of the relative position and the speed difference by the adder.

2. A global search device for a continuous optimization problem, which searches for an optimal solution satisfying a condition that an evaluation function generated using a continuous variable has a minimum value or a maximum value, the global search device for the continuous optimization problem comprising:
an updating unit for updating the continuous variable by a gradient method along a minute change of the evaluation function;
a selector for selecting an eigenstate of a harmonic oscillator according to a Boltzmann distribution; and
an adder for adding a value of a selected eigenstate to the continuous variable as a continuous noise using an existence probability of the selected eigenstate, wherein:
the updating unit repeats updating the continuous variable by the gradient method by adding the continuous noise to the continuous variable by the adder.

3. The global search device for the continuous optimization problem according to claim 2, further comprising:
one or more processors; and
a memory coupled to the one or more processors and storing program instructions that when executed by the one or more processors cause the one or more processors to provide at least: the updating unit; the selector; and the adder.

4. The global search device for a continuous optimization problem according to claim 2, wherein:
when the selector selects the eigenstate of the harmonic oscillator, the selector selects one of excited states in a predetermined range.

5. The global search device for a continuous optimization problem according to claim 4, wherein:
when the selector selects the eigenstate of the harmonic oscillator, the selector chooses a finite numerical number of excited states from a ground state having a lowest energy, and selects one of the excited states.

6. The global search device for a continuous optimization problem according to claim 2, wherein:
the selector always selects a first excited state as the eigenstate of the harmonic oscillator.

7. A global search device for a continuous optimization problem, which searches for an optimal solution satisfying a condition that an evaluation function generated using a continuous variable has a minimum value or a maximum value, the global search device for the continuous optimization problem comprising:
an updating unit for updating the continuous variable by a gradient method along a minute change of the evaluation function;
a selector for selecting an eigenstate of a harmonic oscillator according to a Boltzmann distribution, and randomly selects, as a discrete noise, a value satisfying a condition that an existence probability of a selected eigenstate becomes a peak;
a determination unit for calculating an energy difference before and after adding the discrete noise, and for determining whether a probability depending on a predetermined temperature that depends on the evaluation function is acceptable; and
an adder for setting the discrete noise to be 0 when the probability is not accepted, and for adding the discrete noise selected by the selector to the continuous variable when the probability is accepted, wherein:
the updating unit repeats updating the continuous variable by the gradient method by adding the discrete noise to the continuous variable by the adder.

8. The global search device for the continuous optimization problem according to claim 7, further comprising:
one or more processors; and
a memory coupled to the one or more processors and storing program instructions that when executed by the one or more processors cause the one or more processors to provide at least: the updating unit; the selector; and the adder.

9. The global search device for a continuous optimization problem according to claim 7, wherein:
the temperature is set to a predetermined variable value in an initial state;
when the updating unit repeats updating the continuous variable, the temperature is gradually decreased;
the adder adds the discrete noise together with a Gaussian noise to the continuous variable; and
the Gaussian noise depends on the temperature.

10. The global search device for a continuous optimization problem according to claim 7, wherein:
when the selector selects the eigenstate of the harmonic oscillator, the selector selects one of excited states in a predetermined range.

11. The global search device for a continuous optimization problem according to claim 10, wherein:
when the selector selects the eigenstate of the harmonic oscillator, the selector chooses a finite numerical number of excited states from a ground state having a lowest energy, and selects one of the excited states.

12. The global search device for a continuous optimization problem according to claim 7, wherein:
the selector always selects a first excited state as the eigenstate of the harmonic oscillator.

13. A non-transitory tangible computer readable storage medium comprising instructions being executed by a computer, the instructions including a computer-implemented method for searching for an optimal solution that satisfies a condition that an evaluation function generated using a continuous variable has a minimum value or a maximum value,
the instructions including:
updating the continuous variable by a gradient method along a minute change of the evaluation function;
selecting an eigenstate of a harmonic oscillator according to a Boltzmann distribution;
adding a value of a selected eigenstate to the continuous variable as a continuous noise using an existence probability of the selected eigenstate; and
repeating to update the continuous variable by the gradient method by adding the continuous noise to the continuous variable.

14. The non-transitory tangible computer readable storage medium according to claim 13, wherein:
the selecting of the eigenstate of the harmonic oscillator includes: selecting one of excited states in a predetermined range.

15. The non-transitory tangible computer readable storage medium according to claim 14, wherein:
the selecting of the eigenstate of the harmonic oscillator includes: choosing a finite numerical number of excited states from a ground state having a lowest energy; and selecting one of the excited states.

16. The non-transitory tangible computer readable storage medium according to claim 13, wherein:
the selecting of the eigenstate of the harmonic oscillator includes: always selecting a first excited state as the eigenstate of the harmonic oscillator.

17. A non-transitory tangible computer readable storage medium comprising instructions being executed by a computer, the instructions including a computer-implemented method for searching for an optimal solution that satisfies a condition that an evaluation function generated using a continuous variable has a minimum value or a maximum value,
the instructions including:
updating the continuous variable by a gradient method along a minute change of the evaluation function;
selecting an eigenstate of a harmonic oscillator according to a Boltzmann distribution, and randomly selects, as a discrete noise, a value satisfying a condition that an existence probability of a selected eigenstate becomes a peak;
calculating an energy difference before and after adding the discrete noise, and for determining whether a probability depending on a temperature that is set and depends on the evaluation function is acceptable;
setting the discrete noise to be 0 when the probability is not accepted, and for adding the discrete noise to the continuous variable when the probability is accepted; and
repeating to update the continuous variable by the gradient method by adding the discrete noise to the continuous variable.

18. The non-transitory tangible computer readable storage medium according to claim 17, the instructions further including:
setting the temperature to a predetermined variable value in an initial state;
gradually decreasing the temperature when repeating to update the continuous variable; and
adding the discrete noise together with a Gaussian noise to the continuous variable, wherein:
the Gaussian noise depends on the temperature.

19. T The non-transitory tangible computer readable storage medium according to claim 17, wherein:
the selecting of the eigenstate of the harmonic oscillator includes: selecting one of excited states in a predetermined range.

20. The non-transitory tangible computer readable storage medium according to claim 19, wherein:
the selecting of the eigenstate of the harmonic oscillator includes: choosing a finite numerical number of excited states from a ground state having a lowest energy; and selecting one of the excited states.

21. The non-transitory tangible computer readable storage medium according to claim 17, wherein:
the selecting of the eigenstate of the harmonic oscillator includes: always selecting a first excited state as the eigenstate of the harmonic oscillator.
